(19) United States
(12) Patent Application Publication
(10) Pub. No.: US 2014/0246308 A1
(43) Pub. Date: Sep. 4, 2014

(54) THREE-COMPARTMENT-CELL ONE-PORT TYPE ELECTROLYSIS APPARATUS

(71) Applicant: Dong Won Lim, Seoul (KR)

(72) Inventor: Dong Won Lim, Seoul (KR)

(21) Appl. No.: 14/351,656

(22) PCT Filed: Oct. 11, 2012
(86) PCT No.: PCT/KR2012/008247

§ 371 Date: Apr. 14, 2014

(30) Foreign Application Priority Data
Oct. 21, 2011 (KR) 10-2011-0107963

(51) Int. Cl. C02F 1/461

(52) U.S. Cl. CPC C02F 1/4618
USPC 204/263

(57) ABSTRACT

A three-compartment-cell one-port type electrolysis apparatus having a three-compartment-cell one-port structure which solves the problems of a one-compartment-cell type electrolytic bath and a two-compartment-cell type electrolytic bath, can generate high-purity electrolytic water having strong functionality by consuming only minute amounts of electrolyte, can generate various kinds of electrolyzed water using various electrolytes in a salt state, particularly provides oxidized water or reduced water having an optimized pH according to the various uses by selectively combining the oxidized water and the reduced water, and minimizes the consumption of water.

### BACKGROUND OF THE INVENTION

1. Field of the Invention

The present invention relates to an electrolytic bath as an electrolysis apparatus having a shape in which raw water is supplied to the electrolytic bath and passes through the electrolytic bath in a direct water type, and more particularly, to a three-compartment-cell one-port type electrolysis apparatus having a three-compartment-cell one-port structure.

2. Description of the Related Art

A principle of water hydrolysis is a generalized principle to have about 100 years of history.

An initial one-compartment-cell system obtains electrolytic water using only two electrodes, such as an anode (+) and a cathode (−), in water to which a small amount of electrolyte is added.

A pH of one-compartment-cell type electrolyzed water is alkalescent and contains sodium hypochlorite (NaClO) and has uniform sterilizing power. There are recent reports on prevention of a red tide phenomenon by electrolyzing seawater using one-compartment-cell type equipment (charging of an electrolyte need not to be performed when seawater is electrolyzed). However, an environmental risk has not been verified yet. A non-polluting fully-combusted material using a brown gas of oxygen and hydrogen generated when electrolysis is performed using potassium hydroxide (KOH) as the electrolyte has also been developed. The one-compartment-cell type equipment has also several limitations, such as corrosion of surroundings generated due to a phenomenon that the directly-added electrolyte is not fully decomposed, and enormous occurrence of a chlorine gas.

Two-compartment-cell type equipment illustrated in FIG. 1 has been developed thereafter so as to generate individual (two kinds of) electrolyzed water that is specialized together with the development of an ion exchange membrane.

In the two-compartment-cell type equipment, ion exchange occurs using an ion exchange membrane (separator) installed in the middle of the equipment by applying a direct current (DC) voltage to water to which a small amount of electrolyte (generally, salt) is added, and several byproducts including ampicillin tridydrate, dicloxacillin (HCLOX) and a chlorine gas (Cl₂) are generated at the anode (+). It has been reported that chlorine and hypochlorous acid (HOCl) have strong sterilizing power. Although cleaning methods using electrolyzed water in general industries have been studied together with the development of the two-compartment-cell type equipment, there are limitations, such as occurrence of several variant chemical species and oxidation of a parent material (a material to be cleaned) caused thereby.

### SUMMARY OF THE INVENTION

The present invention provides a three-compartment-cell one-port type electrolysis apparatus which solves the problems of a one-compartment-cell type electrolytic bath and a two-compartment-cell type electrolytic bath, can generate high-purity electrolytic water having strong functionality by consuming only minute amounts of electrolyte, can generate various kinds of electrolyzed water using various electrolytes in a salt state, particularly provides oxidized water or reduced water having an optimized pH according to the various uses by selectively combining the oxidized water and the reduced water, and minimizes the consumption of water.

According to an aspect of the present invention, there is provided a three-compartment-cell one-port type electrolysis apparatus including: a first chamber, of which at least both sidewalls are configured of first and second ion exchange membranes and in which an electrolyte is stored and circulated; a second chamber which has a first water introduction hole and a first water discharge hole formed therein and in which a first electrode is provided and the first ion exchange membrane formed at one side of the first chamber is used as a common partition wall so as to store water or to pass water from the first water introduction hole to the first water discharge hole; a third chamber which has a second water introduction hole and a second water discharge hole formed therein and in which a second electrode is provided and the second ion exchange membrane formed at the other side of the first chamber is used as a common partition wall so as to store water or to pass water from the second water introduction hole to the second water discharge hole; and a connection unit that connects one selected from the first and second water discharge holes and one selected from the first and second water introduction holes.

The first electrode may have one of a positive polarity and a negative polarity, and the second electrode has an opposite polarity to that of the first electrode.

The connection unit may include a selection unit that selects connection of the first or second water discharge hole and the first or second water introduction hole, may further include switching portions that switch and connect one end of a connection pipe to the first or second water discharge hole and switch and connect the other end of the connection pipe to the first or second water introduction hole, and may further include a regulating valve that regulates a flow of water that is discharged from the first or second water discharge hole and introduced into the first or second water introduction hole.

### BRIEF DESCRIPTION OF THE DRAWINGS

The above and other features and advantages of the present invention will become more apparent by describing in detail exemplary embodiments thereof with reference to the attached drawings in which:

FIG. 1 illustrates two-compartment-cell type electrolytic bath equipment according to the related art;

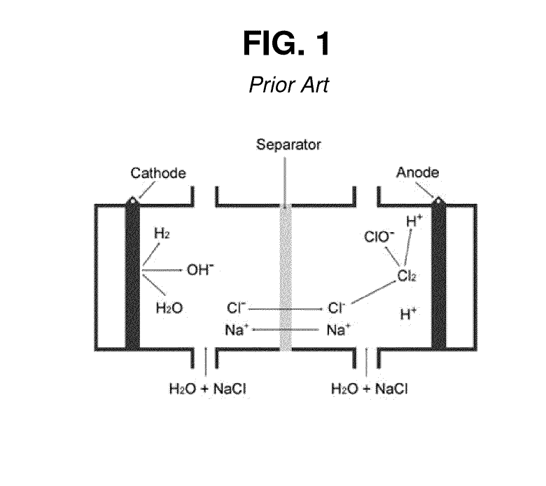

FIG. 2 illustrates (a) a basic structure of a three-compartment-cell type electrolytic bath and a principle of generating electrolytic water and (b) a basic flow path of an electrolyte and electrolytic water in the three-compartment-cell type electrolytic bath;

FIG. 3 illustrates a configuration of a three-compartment-cell one-port type electrolysis apparatus according to an embodiment of the present invention; and

FIG. 4 illustrates a flow path of electrolytic water in the three-compartment-cell one-port type electrolysis apparatus illustrated in FIG. 3.

### DETAILED DESCRIPTION OF THE INVENTION

The present invention will now be described more fully with reference to the accompanying drawings, in which exemplary embodiments of the invention are shown. When reference numerals are added to elements of the drawings, the same reference numerals are used for the same elements as possible even if these elements are represented on different drawings. In the description of the present invention, if it is determined that a detailed description of commonly-used technologies or structures related to the invention may obscure the subject matter of the invention, the detailed description will be omitted.

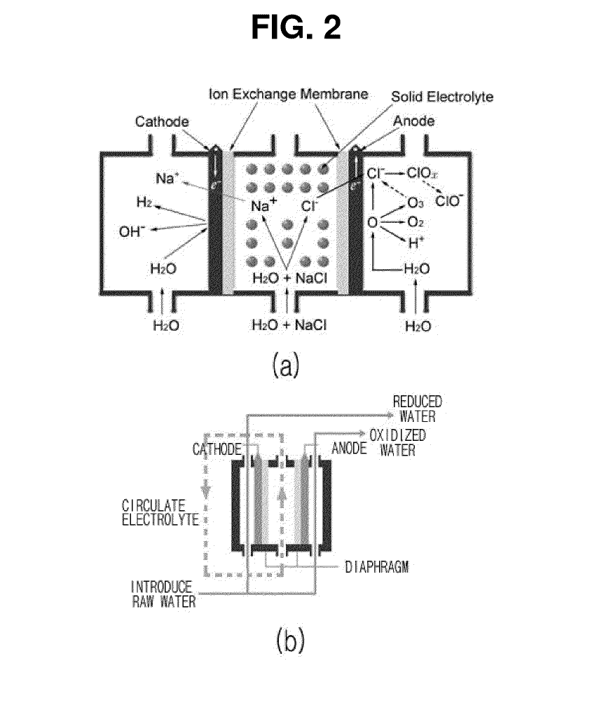

FIG. 2A illustrates a basic structure of a three-compartment-cell type electrolytic bath and a principle of generating electrolytic water, and FIG. 2B illustrates a basic flow path of an electrolyte and electrolytic water in the three-compartment-cell type electrolytic bath.

The three-compartment-cell type electrolytic bath is an electrolysis apparatus having a shape in which raw water is supplied to an electrolytic bath and passes through the electrolytic bath in a direct water type, as illustrated in FIG. 2B. A portion indicated by a dotted line is a circulation system of an electrolyte for smoothly performing electrolysis. In the circulation system of the electrolyte, the electrolyte injected into an intermediate chamber is electrolyzed and is moved to both chambers and thus, acidic oxidized water and alkaline reduced water are generated in both chambers. In this case, acidic oxidized water is generated from an anode, and alkaline reduced water is generated from a cathode. When NaCl is used as the electrolyte, acidic oxidized water has strong sterilizing power, and alkaline reduced water has strong sterilizing power when its pH concentration is high, together with strong cleaning power. Also, characteristics of electrolyzed water generated vary according to types of electrolytes added to the intermediate chamber, and the specification of an electrolytic ystem varies according to types of added electrolytes.

The largest difference between the present invention and an existing electrolysis technology is that no electrolyte, such as salt, is directly added to raw water. The electrolyte is supplied only to the intermediate chamber, and if electrolysis starts, electrolyte ions of the intermediate chamber are moved to an anode chamber or a cathode chamber proportional to an electrolytic current, as illustrated in the electrolysis diagram of FIG. 2A. That is, necessary and smallest amounts of ions can be moved, and ion concentration in electrolytic water can be reduced to minute amounts of electrolyte. Owing these characteristics, high-purity electrolytic water having strong functionality can be generated by consuming only minute amounts of electrolyte. Another large difference is that various kinds of electrolyzed water can be generated using various electrolytes in a salt state.

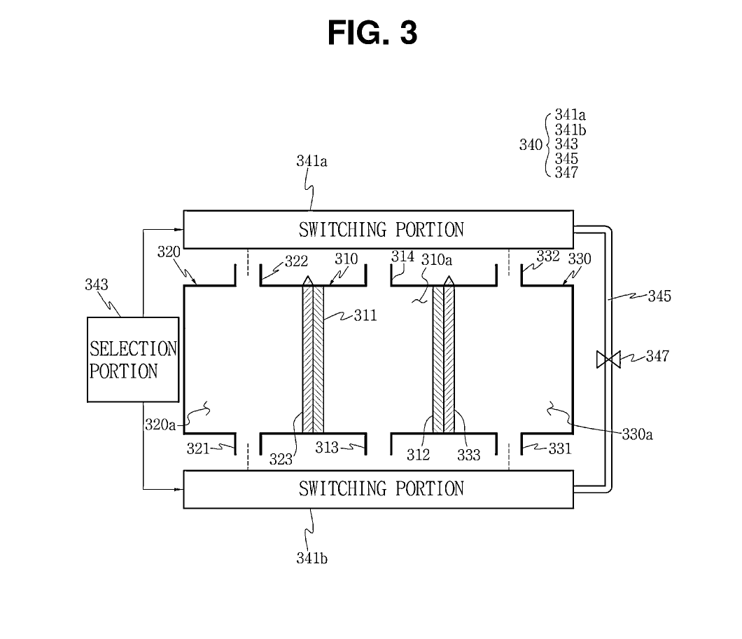

FIG. 3 illustrates a configuration of a three-compartment-cell one-port type electrolysis apparatus according to an embodiment of the present invention. As illustrated in FIG. 3, the three-compartment-cell one-port type electrolysis apparatus may include a first chamber 310 formed in the middle of the apparatus, a second chamber 320 and a third chamber 330 formed at both sides of the first chamber 310, and a connection unit 340 that selectively connects a water discharge hole and a water introduction hole of the second chamber 320 and the third chamber 330.

The first chamber 310 according to the present invention has a first space 310a that is sealed from the outside so as to store and circulate the electrolyte. At least both sidewalls of the first space 310a are configured of a first ion exchange membrane 311 and a second ion exchange membrane 312, and a water introduction hole 313 through which the electrolyte can be introduced and a water discharge hole 314 through which the electrolyte can be discharged, are formed in the first space 310a. The water introduction hole 313 and the water discharge hole 314 may be connected to each other using a circulation pipe (not shown) so that the electrolyte can be circulated, as illustrated in FIG. 2B.

The second chamber 320 according to the current embodiment has a second space 320a that is sealed from the outside so as to store and pass water in a direct water type. The first ion exchange membrane 311 may be formed at one side of the first chamber 310 and may be used as a common partition wall (or a diaphragm), and a water introduction hole 321 through which water can be introduced and a water discharge hole 322 through which water can be discharged, are formed in the second space 320a. A first electrode 323 is provided in the second space 320a.

The third chamber 330 according to the current embodiment has a third space 330a that is sealed from the outside so as to store water and pass water in a direct water type. The second ion exchange membrane 312 may be formed at one side of the first chamber 310 and may be used as a common partition wall (or a diaphragm), and a water introduction hole 331 through which water can be introduced and a water discharge hole 332 through which water can be discharged, are formed in the third space 330a. A second electrode 333 is provided in the third space 330a.

Thus, in the current embodiment, the first space 310a of the first chamber 310 and the second space 320a of the second chamber 320 are adjacent to each other by the border of the first ion exchange membrane 311 as the diaphragm, and the first space 310a of the first chamber 310 and the third space 330a of the third chamber 330 are adjacent to each other by the border of the second ion exchange membrane 312 as the diaphragm.

In the current embodiment, the first electrode 323 have one of a positive (+) polarity and a negative (−) polarity, and the second electrode 333 has an opposite polarity to that of the first electrode 323, and an example in which the first electrode 323 is a cathode having a negative polarity and the second electrode 333 is an anode having a positive polarity, will be described.

The connection unit 340 according to the current embodiment connects one of the water discharge hole 322 of the second chamber 320 and the water discharge hole 332 of the third chamber 330 and one of the water introduction hole 321 of the second chamber 320 and the water introduction hole 331 of the third chamber 330 according to user's selection. As illustrated in FIG. 3, the connection unit 340 may include switching portions 341a and 341b, a selection portion 343, a connection pipe 345, and a regulating valve 347.

The switching portions 341a and 341b according to the current embodiment switch and connect one end of the connection pipe 345 to the water discharge hole 322 of the second chamber 320 or the water discharge hole 332 of the third chamber 330 and switch and connect the other end of the connection pipe 345 to the water introduction hole 321 of the second chamber 320 or the water introduction hole 331 of the third chamber 330.

The selection portion 343 according to the current embodiment is used to control a switching connecting operation of the switching portions 341a and 341b according to the user's selection.

The regulating valve 347 according to the current embodiment is used to regulate a flow of water that is discharged from one of two water discharge holes 322 and 332 and is introduced into one of two water introduction holes 321 and 331. For example, the regulating valve 347 may be installed on the connection pipe 345. Also, the regulating valve 347 may cause an operation to be automatically regulated according to the user's selection using the selection portion 343, for example, and alternatively, to be manually regulated.

Subsequently, as described above, an example of an operation of the three-compartment-cell one-port type electrolysis apparatus according to the current embodiment of the present invention will be described.

### First Operational Example

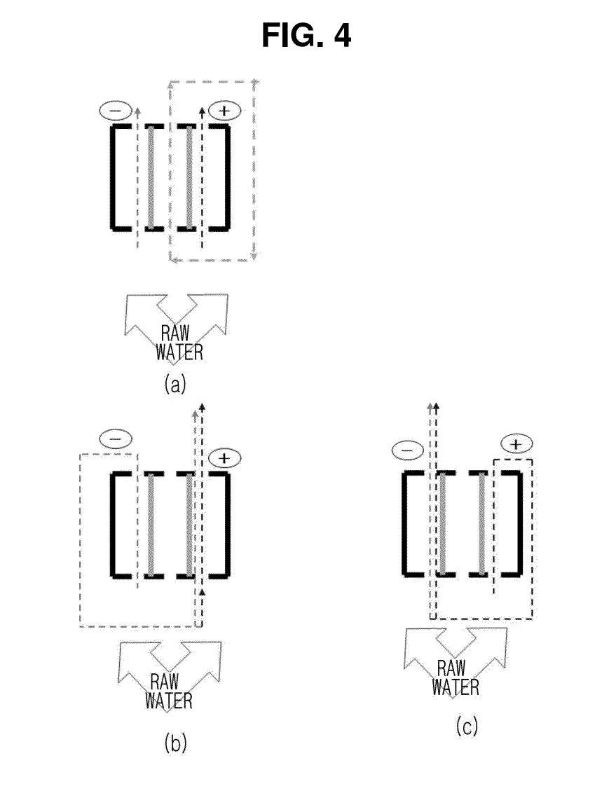

First, when the switching portions 341a and 341b of the connection unit 340 do not operate, i.e., in case of the first operational example, as described above with reference to FIG. 2, if the electrolyte is supplied to the intermediate, first chamber 310 and raw water is supplied to the second chamber 320 as a cathode chamber and the third chamber 330 as an anode chamber that are placed at both sides of the first chamber 310 and passes through the second chamber 320 and the third chamber 330 in a direct water type, the electrolyte introduced into the intermediate, first chamber 310 is electrolyzed into both the second chamber 320 and the third chamber 330 and is moved. Thus, alkaline reduced water and acidic oxidized water are generated in the second chamber 320 in which the cathode 323 exists, and the third chamber 330 in which the anode 333 exists, and are discharged through the water discharge holes 322 and 332. A flow path of electrolytic water in the first operational example is formed, as illustrated in FIG. 4A. FIG. 4A is substantially the same as FIG. 2B.

### Second Operational Example

Next, if the three-compartment-cell one-port type electrolysis apparatus operates like in the above-described first operational example and operates the switching portions 341 a and 341 b of the connection unit 340 so that both ends of the connection pipe 345 are connected to the water discharge hole 322 of the second chamber 320 and the water introduction hole 331 of the third chamber 330, respectively, i.e., in case of the second operational example, alkaline reduced water discharged from the water discharge hole 322 of the second chamber 320 is introduced into the water introduction hole 331 of the third chamber 330 via the connection pipe 345, is re-electrolyzed and reacted in the third chamber 330, is combined with acidic oxidized water and then is discharged to the water discharge hole 332. In this case, it is basic that raw water is introduced into the water introduction hole 321 of the second chamber 320. However, embodiments of the present invention are not limited thereto, and raw water may be continuously introduced into the water introduction hole 331 of the third chamber 330. Also, the regulating valve 347 may be regulated according to selection so that the flow of alkaline reduced water introduced into the water introduction hole 331 of the third chamber 330 can be regulated. A flow path of electrolytic water in the second operational example is formed, as illustrated in FIG. 4B. If the three-compartment-cell one-port type electrolysis apparatus operates in this way, acidic oxidized water discharged to the water discharge hole 332 of the third chamber 330 causes the amount of residual chlorine to be increased so that sterilizing power can be maximized and pH concentration can be reduced and corrosiveness caused by strongly acid can be reduced. Also, even when only acidic oxidized water is required, alkaline reduced water may not be discarded and may be re-used so that water can be saved.

### Third Operational Example

Also, if the three-compartment-cell one-port type electrolysis apparatus operates like in the above-described first operational example or second operational example and operates the switching portions 341a and 341b of the connection unit 340 so that both ends of the connection pipe 345 are connected to the water discharge hole 332 of the third chamber 330 and the water introduction hole 321 of the second chamber 320, respectively, i.e., in case of the third operational example, acidic oxidized water discharged from the water discharge hole 332 of the third chamber 330 is introduced into the water introduction hole 321 of the second chamber 320 via the connection pipe 345, is re-electrolyzed and reacted in the second chamber 320, is combined with alkaline reduced water and then is discharged to the water discharge hole 322. In this case, it is basic that raw water is introduced into the water introduction hole 331 of the third chamber 330. However, embodiments of the present invention are not limited thereto, and raw water may be continuously introduced into the water introduction hole 321 of the second chamber 320. Also, the regulating valve 347 may be regulated according to selection so that the flow of acidic oxidized water introduced into the water introduction hole 321 of the second chamber 320 can be regulated. A flow path of electrolytic water in the third operational example is formed, as illustrated in FIG. 4C. If the three-compartment-cell one-port type electrolysis apparatus operates as described above, alkaline reduced water having an optimized pH according to the user's use can be obtained. Also, even when only alkaline reduced water is required, acidic oxidized water may not be discarded and may be re-used so that water can be saved.

Like in the second and third operational examples, a type in which, in the three-compartment-cell electrolytic bath, raw water is introduced into one water introduction hole, is electrolyzed in two polarity chambers and then is discharged through one water discharge hole, is referred to as so-called a three-compartment-cell one-port type.

As described above, according to the present invention, the problems of a one-compartment-cell type electrolytic bath and a two-compartment-cell type electrolytic bath can be solved, and high-purity electrolytic water having strong functionality can be generated by consuming only minute amounts of electrolyte, and various kinds of electrolyzed water can be generated using various electrolytes in a salt state, particularly oxidized water or reduced water having an optimized pH according to the various uses can be provided by selectively combining the oxidized water and the reduced water, and the consumption of water can be minimized.

While this invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A three-compartment-cell one-port type electrolysis apparatus comprising:
a first chamber, of which at least both sidewalls are configured of first and second ion exchange membranes and in which an electrolyte is stored and circulated;
a second chamber which has a first water introduction hole and a first water discharge hole formed therein and in which a first electrode is provided and the first ion exchange membrane formed at one side of the first chamber is used as a common partition wall so as to store water or to pass water from the first water introduction hole to the first water discharge hole;
a third chamber which has a second water introduction hole and a second water discharge hole formed therein and in which a second electrode is provided and the second ion exchange membrane formed at the other side of the first chamber is used as a common partition wall so as to store water or to pass water from the second water introduction hole to the second water discharge hole; and
a connection unit that connects one selected from the first and second water discharge holes and one selected from the first and second water introduction holes.

2. The three-compartment-cell one-port type electrolysis apparatus of claim 1, wherein the first electrode has one of a positive polarity and a negative polarity, and the second electrode has an opposite polarity to that of the first electrode.

3. The three-compartment-cell one-port type electrolysis apparatus of claim 1, wherein the connection unit comprises a selection unit that selects connection of the first or second water discharge hole and the first or second water introduction hole.

4. The three-compartment-cell one-port type electrolysis apparatus of claim 1, wherein the connection unit further comprises switching portions that switch and connect one end of a connection pipe to the first or second water discharge hole and switch and connect the other end of the connection pipe to the first or second water introduction hole.

5. The three-compartment-cell one-port type electrolysis apparatus of claim 1, wherein the connection unit further comprises a regulating valve that regulates a flow of water that is discharged from the first or second water discharge hole and introduced into the first or second water introduction hole.
